(19) United States
(12) Patent Application Publication
(10) Pub. No.: US 2010/0188849 A1
(43) Pub. Date: Jul. 29, 2010

(54) LED LIGHTING FIXTURE

(75) Inventors: Wenzheng Luo, Chengdu (CN); Ming Zhang, Chengdu (CN); Ying Xu, Chengdu (CN)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: SICHUAN SUNFOR LIGHT CO., LTD., Chengdu (CN)

(21) Appl. No.: 12/670,342

(22) PCT Filed: Dec. 3, 2007
(86) PCT No.: PCT/CN07/03429

§ 371 Date: Feb. 17, 2010

(30) Foreign Application Priority Data
Jul. 27, 2007 (CN) 200710049618.7

(51) Int. Cl. F21S 4/00

(52) U.S. Cl. 362/249.02

(57) ABSTRACT

The invention provides an LED lighting fixture capable of adjusting light distribution very conveniently. The LED lighting fixture of the invention includes LED light sources and radiator, the radiator is provided with mounting surface arrays and the LED light sources are mounted on the mounting surface arrays. The LED light sources are mounted on the mounting surface arrays, thus realizing secondary distribution of the LED light source and being capable of adjusting light distribution very conveniently as required; separate design of the radiator and the support frame facilitates realization of diversified appearances; and integrated heat radiation design fulfills heat radiation requirements. The LED lighting fixture can be a good substitute for the conventional lighting fixtures, has the advantages of being environment-friendly, efficient, energy-saving, safe and reliable, and can be widely applied to highways, urban roads, industrial parks, schools, squares, tunnels, etc.

### FIELD OF THE INVENTION

The invention relates to lighting technology, in particular to an LED lighting fixture.

### TECHNICAL BACKGROUND

The existing LED lighting fixture consists of at least two LED point light sources. The LED light sources have good directionality, which results in the difficulty in light distribution when a plurality of LED point light sources are integrated into a high-power lighting fixture.

The majority of various existing LED lighting fixtures have the disadvantages of the conventional lighting fixtures and neglect the problems of on-site light distribution curves, etc., which seriously affects lighting effect of the lighting fixtures. A high-power LED street lamp was disclosed in CN1821651, but a single LED plus a lens was adopted in the street lamp, resulting in complex manufacturing process, increased light loss and complex procedures of adjusting light distribution direction by a dialyte lens. An LED street lamp was disclosed in CN2842182 with consideration of mounting angles of LEDs, but assembly construction surfaces are so many that the manufacturing process is complex.

### SUMMARY OF THE INVENTION

A technical problem to be solved by the invention is to provide an LED lighting fixture capable of adjusting light distribution very conveniently.

The technical solution of the invention for solving the technical problem is that an LED lighting fixture comprises LED light sources and a radiator, the radiator is provided with mounting surface arrays, and the LED light sources are mounted on the mounting surface arrays.

The invention has the following advantages: the LED light sources are mounted on the mounting surface arrays, thus realizing secondary distribution of the LED light sources and being capable of adjusting light distribution very conveniently as required; separate design of the radiator and the support frame facilitates realization of diversified appearances; and integrated heat radiation design helps fulfill heat radiation requirements. The invention can be a good substitute for the conventional lighting fixtures, has the advantages of being environment-friendly, efficient, energy-saving, safe and reliable, and can be widely applied to highways, urban roads, industrial parks, schools, squares, tunnels, etc.

### BRIEF DESCRIPTION OF THE DRAWINGS

FIG. 1 is a perspective view of the invention.

FIG. 2 is a top view of the invention.

FIG. 3 is a partially sectional perspective view of the invention.

FIG. 4 is a sectional view of the invention.

FIG. 5 is a sectional view of the invention.

FIG. 6 is a top view of the radiator of the invention.

FIG. 7 is a top view of the invention.

FIG. 8 is a top view of the invention with a rain housing uncovered.

FIG. 9 is a sectional view of the invention.

### DETAILED DESCRIPTION OF THE INVENTION

The LED lighting fixture of the invention comprises LED light sources 3 and radiator 1, the radiator 1 is provided with mounting surface arrays and the LED light sources 3 are mounted on the mounting surface arrays.

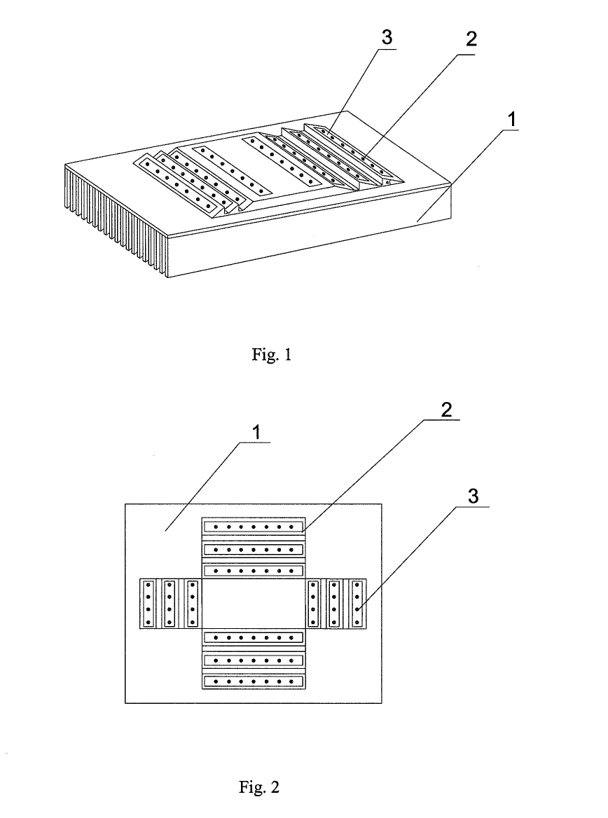

The mounting surface arrays are inclined mounting surface arrays or curved mounting surface arrays, in which the center is a plane and at least one side around the plane is provided with the mounting surface arrays. For example, the mounting surface, in which the center is a plane and the both sides of the plane are provided with the inclined mounting surface arrays, can be used, as shown in FIG. 1. Alternatively, the mounting surface, in which the center is a plane and the all the sides around the plane are provided with the inclined mounting surface arrays, can be used, as shown in FIG. 2. Other modes can be used also.

Preferably, the mounting surface arrays are in the form of toothed inclined mounting surfaces 2 or toothed curved mounting surfaces, as shown in FIG. 1 and FIG. 5.

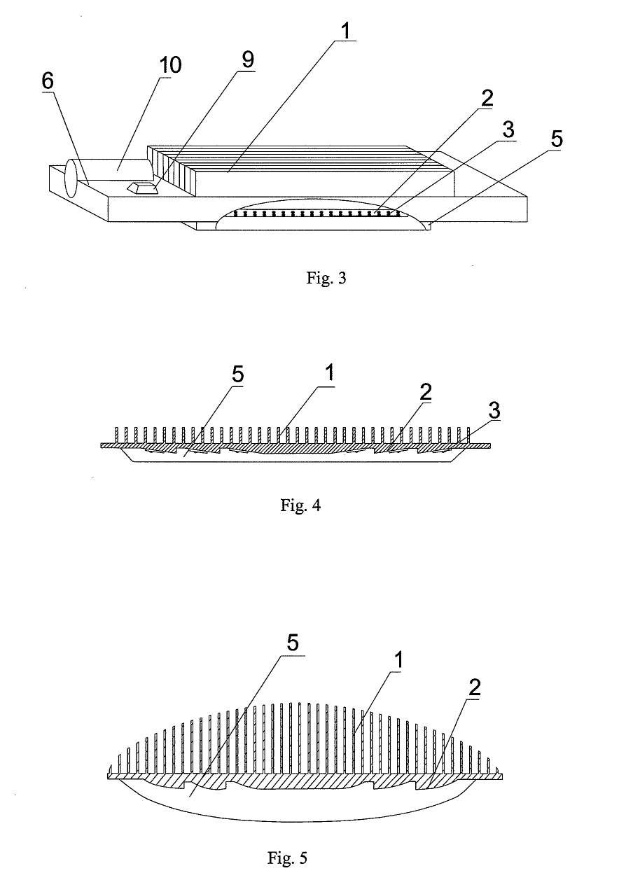

The radiator 1 is mounted on the support frame 6, as shown in FIG. 3. The included angle α between the toothed inclined mounting surfaces 2 and the level surfaces of the radiator 1 is not smaller than 3° and not greater than 60°. The included angle α between each toothed inclined mounting surface 2 and the level surfaces of the radiator 1 can be different so as to facilitate light adjustment in different directions. Inclining direction of the toothed inclined mounting surfaces 2 can be in any direction so as to meet lighting requirements of different areas. For example, when the lighting fixture is used as a street lamp for a pavement, the inclining direction of the toothed inclined mounting surfaces 2 is preferably towards the pavement to allow more light from the LED light source 3 to be distributed on the pavement so as to meet requirements for use.

The LED light sources 3 can be secured to the toothed inclined mounting surfaces 2 at the radiator 1 by heat-conducting silica gel and fitting screws, thus good heat radiation effect from the LED light sources 3 to the radiator 1 can be obtained. The toothed inclined mounting surfaces 2 can be designed according to mounting requirements of the LED light sources 3, which can be a plane as shown in FIG. 4 and also can be curved surface as shown in FIG. 5.

The lighting angle β of the LED light sources 3 preferably ranges from 30° to 120°, in this case, the lighting angle 13 can match the inclined angle α of the toothed inclined mounting surfaces 2 at the radiator 1 so as to meet the requirements of irradiation range of lighting fixtures with different heights. For example, the angle α between the toothed inclined mounting surfaces 2 and the level surfaces of the radiator 1 can be adjusted and the lighting angle β of the LED can be selected according to different heights of street lamp posts so as to obtain the optimum light distribution curve.

The LED light sources 3 of the invention preferably consist of more than two LEDs and heat radiating aluminum-based or copper-based PCBs to facilitate the collocation of different power requirements. For example, six-array LED light sources 3 can be selected for 60 W power, and each array of the LED light sources 3 comprises ten high-power LEDs of 1 W.

The radiator 1 and the mounting surface arrays of the invention are integratedly formed as a whole by machining or casting, etc., which can be made by aluminum or copper with good heat conductivity. The integrated structure avoids separation of the radiator 1 from the mounting surfaces of the LED light sources 3, thus reducing thermal contact resistance among a plurality of contact surfaces, increasing heat-conduction efficiency and improving heat radiation capacity.

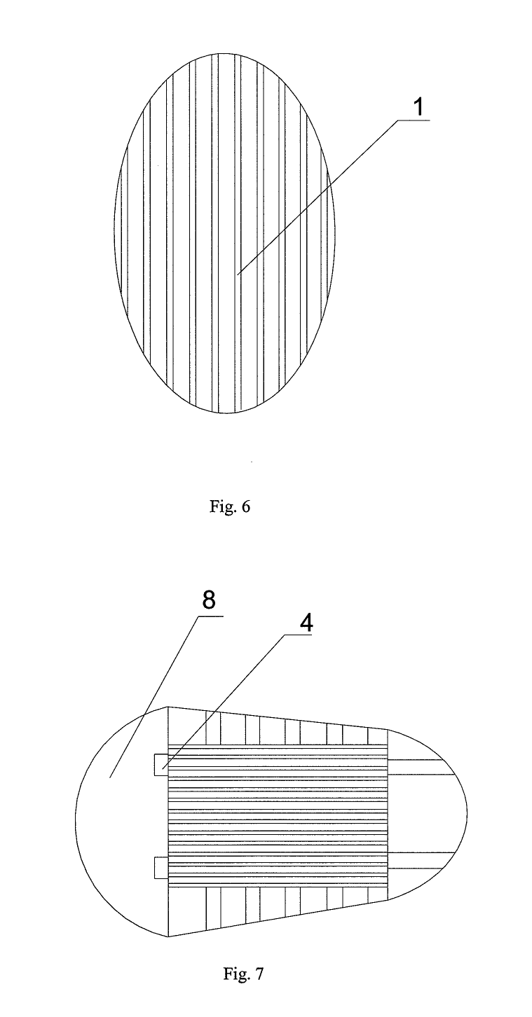

The overall appearance of the radiator 1 can be cuboid, sphere, ellipsoid or other shapes, such as the cuboid as shown in FIG. 1 and the ellipsoid as shown in FIG. 6. The radiator 1 can be in the form of radiating fins which can be arranged in regular straight teeth as shown in FIG. 3 and FIG. 4, and can also be in the form of curved surface shape as shown in FIG. 5. Other shapes can also be used. The straight-teeth arrangement mode can be easily realized by machining, and the heat radiation area is easy to be calculated, while the radiating fins of curved is surface shape have nice appearance and are suitable for aesthetic needs on certain occasions.

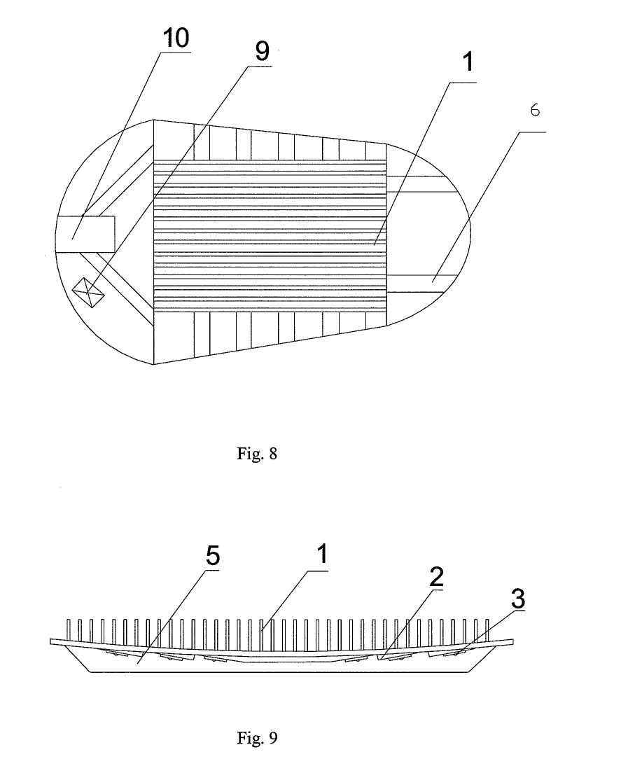

The radiator 1 and the support frame 6 of the invention are two main separate parts. The support frame 6 can be in the form of an oblong or a circular arc as shown in FIG. 3 and FIG. 7 and can be in the form of other shapes so as to realize diversified appearances of the lighting fixture and meet different needs of decorations and collocations. The support frame 6 is also provided with a rain housing 8 which can protect components such as a constant-current driver 9 and can be mounted on the support frame 6 by a flap 4. However, the mounting position of the rain housing 8 cannot shield off the radiator 1 so as to avoid adversely affecting the heat radiation capacity. A top view of the lighting fixture with the rain housing 8 covered is shown in FIG. 7, and a top view thereof with the rain housing 8 uncovered is shown in FIG. 8.

A transparent shade 5 is mounted on the radiator 1 and can protect the LED light sources 3 and allow the lighting fixture to have nice appearance. The radiator 1, the LED light sources 3 and the transparent lampshade 5 are integrated as a whole and mounted on the support frame 6 by screws and fasteners. The constant-current driver 9 is fixed on the support frame 6 by screws and provides steady working current for the LED light sources 3. The support frame 6 is connected with a lamp post by a mounting hole 10.

In order to be more favorable for light distribution of the invention, the level surface of the radiator 1 can also be arranged as a curved surface as shown in FIG. 9.

While the invention has been illustrated and described with reference to the preferred embodiments thereof, it will be understood by those skilled in the art that various changes in the forms and details may be made within the scope of claims.

1. An LED lighting fixture, comprising LED light sources and a radiator, wherein the radiator is provided with mounting surface arrays, the LED light sources are mounted on the mounting surface arrays, and the mounting surface arrays are inclined mounting surface arrays or curved mounting surface arrays, in which the center is a plane and at least one side around the plane is provided with the mounting surface arrays, the mounting surface arrays being provided in a form of toothed inclined mounting surfaces or toothed curved mounting surfaces.

2-4. (canceled)

5. The LED lighting fixture according to claim 1, wherein an included angle α between each of the toothed inclined mounting surfaces and a level surface of the radiator is not smaller than 3° and not greater than 60°.

6. The LED lighting fixture according to claim 1, wherein the radiator is mounted on a support frame.

7. The LED lighting fixture according to claim 6, wherein the support frame is provided with a constant-current driver.

8. The LED lighting fixture according to claim 6, wherein the support frame is provided with a rain housing.

9. The LED lighting fixture according to claim 1, wherein the radiator and the mounting surface arrays are integratedly manufactured.

10. The LED lighting fixture according to claim 1, wherein the LED light sources comprise LEDs and heat radiating aluminum-based or copper-based PCBs.
